(19) United States
(12) Patent Application Publication
(10) Pub. No.: US 2024/0076507 A1
(43) Pub. Date: Mar. 7, 2024

(54) HYDROPHOBIC PROTECTIVE COATING FOR PAINTED AND NON-PAINTED METALLIC SURFACES

(71) Applicant: Green Products & Technologies, LLC, Melbourne, FL (US)

(72) Inventors: John T. MacDonald, Grant, FL (US); John T. MacDonald, III, Palm Bay, FL (US)

(73) Assignee: Green Products & Technologies, LLC, Melbourne, FL (US)

(21) Appl. No.: 18/239,550

(22) Filed: Aug. 29, 2023

Related U.S. Application Data
(60) Provisional application No. 63/403,171, filed on Sep. 1, 2022.

(51) Int. Cl. C09D 5/16; C09D 7/20; C09D 7/61

(52) U.S. Cl. CPC C09D 5/1681; C09D 7/20; C09D 7/61

(57) ABSTRACT

Coatings, and methods for protection of metal and other articles. The coatings provided herein are hydrophobic (water-repelling) and flame- and heat-resistant and are useful for protection of non-porous surfaces such as metal articles. The coatings are useful to protect cars, boats, and trucks for personal use, and all types of vehicles for industrial and transport and construction purposes.

### CROSS-REFERENCE TO RELATED APPLICATION

This application claims the benefit of U.S. Provisional Patent Application No. 63/403,171, filed on Sep. 1, 2022, which is incorporated by reference herein in its entirety.

### FIELD

The present disclosure relates generally to protective hydrophobic coatings for metal objects. Various embodiments are contemplated for use in the transportation, manufacturing, and medical fields, among others.

### BACKGROUND

Rust and aging or damage to the surface of metal articles has been a problem for many years. Coatings that are anticorrosive, therefore, have great benefit in protecting metal surfaces and prolonging the life of metal articles, as well as providing other beneficial properties. However, a major problem with such hydrophobic or superhydrophobic coatings is a lack of durability or wear resistance.

Ceramic coatings have become popular in the automotive industry for protecting the finish/exterior surface of automobiles. Despite extravagant claims for these products, the coatings have not actually performed as advertised. Most of the coatings for automobiles on the market today are waxes or silicone polymer-based paint protectants that create an effective, but temporary, glossy hydrophobic surface that can last longer than a traditional wax.

Some products offer a permanent or semipermanent ceramic coating that are more protective but have significant shortcomings. Some can provide a 9H surface hardness, which can protect against scratches and chips, but do not possess significant hydrophobic properties and gloss sufficient to form a desirable surface without an additional topcoat of silicone polymer-based protectant that needs to be reapplied periodically. This destroys the convenience of long wear assertedly provided by the ceramic coating. Another shortcoming is that this type of coating frequently has a drastically different thermal expansion rate and flexibility compared to the surface to which it is applied, thereby causing premature failure due to the formation of microscopic cracks that allow atmospheric or chemical contaminants to get beneath the coating and damage the substrate. When this occurs, the coatings must be removed by wet sanding or abrasive mechanical polishing and then reapplied. Further, these ceramic coatings are difficult to apply properly and consistently—the products must be applied in small sections under ideal conditions or noticeable variations will be apparent, including high spots, lines, variations in gloss, and other visible defects in the coating.

Superhydrophobic products work by creating a micro- or nano-sized structure on a surface which has super-repellent properties. These structures are by their nature very delicate and can be damaged by wear, cleaning, or any sort of friction, thus losing the hydrophobic properties. Thus, most coatings of this type are used mainly on parts in a sealed environment or that are otherwise not exposed to wear or damage to protect from moisture and to prevent corrosion and are not suitable for many surfaces without frequent re-application, which is typically inconvenient and/or undesirable to consumers.

The discussion of shortcomings and needs existing in the field prior to the present disclosure is in no way an admission that such shortcomings and needs were recognized by those skilled in the art prior to the present disclosure.

### SUMMARY

Various embodiments solve the above-mentioned problems and provide methods and compositions, including hydrophobic coatings that are able to deliver high quality in multiple key areas: (1) ease and consistency in application; (2) sufficient gloss and hydrophobicity so that an additional top coat is not needed; (3) a hardness of about 9H or more on the Mohs scale of hardness (a qualitative ordinal scale, from 1 to 10, characterizing scratch resistance of various materials through the ability of a harder material to scratch a softer material) while still being flexible enough to avoid forming microcracks; and (4) compatibility with multiple surfaces, including but not limited to bare metals, coated materials, finished fiberglass, and gelcoat surfaces. Such coatings are provided by various embodiments described herein.

Various embodiments relate to a superhydrophobic coating composition comprising, consisting essentially of, or consisting of: (a) about 0% to about 98.9% by weight trimethyoxymethylsilane, 98% pure; (b) about 0% to about 98.9% by weight triethoxy(octyl)silane, 97% pure; (c) about 1% to about 50% by weight dimethylpolysiloxane; and (d) about 0.1% to about 10% by weight titanium diisopropoxide bis(acetylacetonate) 75% in isopropanol.

Various embodiments relate to a superhydrophobic coating comprising, consisting essentially of, or consisting of: (a) about 10% to about 90% by weight trimethyoxymethylsilane, 98% pure; (b) about 1% to about 85% by weight triethoxy(octyl)silane, 97% pure: (c) about 5% to about 40% by weight dimethylpolysiloxane; and (d) about 0.5% to about 8% by weight titanium diisopropoxide bis(acetylacetonate) 75% in isopropanol.

Various embodiments relate to a superhydrophobic coating composition comprising, consisting essentially of, or consisting of:
(a) about 25% to about 70% by weight trimethyoxymethylsilane, 98% pure;
(b) about 5% to about 50% by weight triethoxy(octyl)silane, 97% pure;
(c) about 10% to about 30% by weight dimethylpolysiloxane; and
(d) about 1% to about 5% by weight titanium diisopropoxide bis(acetylacetonate) 75% in isopropanol.

Various embodiments relate to a superhydrophobic coating composition comprising, consisting essentially of, or consisting of:
(a) about 45% to about 65% by weight trimethyoxymethylsilane, 98% pure;
(b) about 10% to about 30% by weight triethoxy(octyl)silane, 97% pure;
(c) about 15% to about 25% by weight dimethylpolysiloxane; and
(d) about 2% to about 4% by weight titanium diisopropoxide bis(acetylacetonate) 75% in isopropanol.

Various embodiments relate to a superhydrophobic coating composition comprising, consisting essentially of, or consisting of:
(a) about 58.7% by weight trimethyoxymethylsilane, 98% pure;
(b) about 18.6% by weight triethoxy(octyl)silane, 97% pure;
(c) about 20.6% by weight dimethylpolysiloxane; and
(d) about 2.1% by weight titanium diisopropoxide bis(acetylacetonate) 75% in isopropanol.

Various embodiments relate to articles of manufacture coated with the superhydrophobic coatings described herein.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures.

FIG. 1A is a photograph showing an untreated metal coupon.

FIG. 1B is a photograph showing a metal coupon treated with the formulation according to Example 1.

FIG. 1C is a photograph showing an untreated metal coupon and a ruler to show its dimensions.

FIG. 1D is a photograph showing an untreated metal coupon and a ruler to show its dimensions.

FIG. 2A is an example according to various embodiments, illustrating a first still frame image from a video demonstrating the consequences of exposing a first side of an untreated cloth applicator sponge to a butane torch.

FIG. 2B is an example according to various embodiments, illustrating a second still frame image from a video demonstrating the consequences of exposing a first side of an untreated cloth applicator sponge to a butane torch.

FIG. 2C is an example according to various embodiments, illustrating a third still frame image from a video demonstrating the consequences of exposing a first side of an untreated cloth applicator sponge to a butane torch.

FIG. 3A is an example according to various embodiments, illustrating a first still frame image from a video demonstrating the consequences of exposing a first side of a treated cloth applicator sponge, which has been in contact with a formulation according to Example 1, to a butane torch.

FIG. 3B is an example according to various embodiments, illustrating a second still frame image from a video demonstrating the consequences of exposing a first side of a treated cloth applicator sponge, which has been in contact with a formulation according to Example 1, to a butane torch.

FIG. 3C is an example according to various embodiments, illustrating a third still frame image from a video demonstrating the consequences of exposing a first side of a treated cloth applicator sponge, which has been in contact with a formulation according to Example 1, to a butane torch.

FIG. 4A is a photograph showing an untreated an untreated cloth applicator sponge and a ruler to show its dimensions.

FIG. 4B is a photograph showing an untreated an untreated cloth applicator sponge and a ruler to show its dimensions.

FIG. 4C is a photograph showing an untreated an untreated cloth applicator sponge and a ruler to show its dimensions.

FIG. 5 is an example according to various embodiments, illustrating a still frame of a video demonstrating water running off of a car hood that has been treated with the formulation according to Example 1.

FIG. 6 is a chart showing the contact angle results obtained in Example 9.

FIG. 7 is a magnified image showing the contact angle results obtained in Example 9.

FIG. 8 is a magnified image showing the contact angle results obtained in Example 9.

FIG. 9 is a magnified image showing the contact angle results obtained in Example 9.

It should be understood that the various embodiments are not limited to the examples illustrated in the figures.

### DETAILED DESCRIPTION

### Introduction and Definitions

This disclosure is written to describe various embodiments to a person having ordinary skill in the art, who will understand that this disclosure is not limited to the specific examples or embodiments described. The examples and embodiments are single instances of the disclosure which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure. In many instances, the term “about” may include numbers that are rounded to the nearest significant figure. For example, based on the context, a skilled artisan may appreciate that the term “about” means plus or minus 20 percent of the recited value, so that, for example, “about 0.125” means 0.125±0.025, and “about 1.0” means 1.0±0.2.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art. Although various methods and materials similar or equivalent to those described herein may be used in the practice or testing of various embodiments, suitable methods and materials are described below. However, the skilled artisan understands that the methods and materials used and described are examples and may not be the only ones suitable for according to various embodiments. Moreover, as measurements are subject to inherent variability, any temperature, weight, volume, time interval, pH, salinity, molarity or molality, range, concentration and any other measurements, quantities or numerical expressions given herein are intended to be approximate and not exact or critical figures unless expressly stated to the contrary.

In this specification and in the claims that follow, reference will be made to a number of terms that shall be defined to have the following meanings unless a contrary intention is apparent.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

“Standard temperature and pressure” generally refers to 25° C. and 1 atmosphere. Standard temperature and pressure may also be referred to as “ambient conditions.” Unless indicated otherwise, parts are by weight, temperature is in ° C., and pressure is at or near atmospheric. The terms “elevated temperatures” or “high-temperatures” generally refer to temperatures of at least 100° C.

“Hydrophobic” means having a droplet contact angle of between about 90 degrees to about 150 degrees.

“Superhydrophobic” means having a droplet contact angle greater than about 150 degrees.

“Microcrack” or “microcracks” refers to a type of material damage consisting of cracks small enough to require magnification to observe.

“Pure” means not mixed or adulterated with any other substance or material. A percentage of purity, such as “98% pure” means that the indicated component represents at least 98% by weight of the overall composition. For example, a component listed as “trimethyoxymethylsilane, 98% pure” means that the component may be a composition comprising at least 98% by weight of trimethyoxymethylsilane.

### Overview

Various embodiments relate to compounds, coatings, and methods for protection of metal and other articles. The coatings provided herein may be hydrophobic (water-repelling) and flame- and heat-resistant and may be useful for protection of non-porous surfaces such as metal articles. The coatings may be useful to protect cars, boats, and trucks for personal use, and all types of vehicles for industrial and transport and construction purposes. The coatings may also be useful for protection of non-porous surfaces in manufacturing, construction, and in many other fields. Articles suitable for use with various embodiments include any articles of manufacture for which it is desirable to provide a hydrophobic and/or flame-resistant protective coating, including machine parts, medical equipment, automotive coatings, and the like.

Superhydrophobic coatings provided by various embodiments may have important applications in the maritime industry. The coatings may be used to reduce friction/drag on the hull of boats and ships, including metal and fiberglass hulls, thus increasing fuel efficiency, and allowing ships to increase their speed or range while reducing fuel costs. They may also reduce corrosion on surfaces and prevent marine organisms from growing on a ship's hull.

In the automotive industry, the coatings according to various embodiments may be useful as coatings for any car, truck, or other vehicle, for example in coatings for a vehicle windshield in order to prevent rain droplets from clinging to the glass, as well as a protectant for metal and other parts, and use on construction or digging equipment, mining equipment, masonry and concrete trucks and equipment, and the like.

In the medical industry, coatings according to various embodiments may be used to produce more lubricious, bacterial resistant surfaces due to their high water repellence. Thus, the coatings may be used on surgical tools, medical devices, and the like.

Additional uses for coatings according to various embodiments include allowing easy removal of salt deposits on the surface without having to use fresh water. Furthermore, these coatings may be used in harvesting minerals from seawater or brine. The coatings may be used on varied surfaces other than metal or coated metal, including fiberglass, textiles, plastics, electronic components, and the like.

### VARIOUS EMBODIMENTS

Compositions according to various embodiments comprise silane compounds that may undergo hydrolysis to form silicon carbide, a material second in hardness to diamond which also has very good thermal conductivity, resistance to oxidation, and near insolubility except in molten alkalis and molten iron. Silicon carbide provides the inventive compositions with extreme hardness and scratch, abrasion, and chip resistance.

Through experimentations, it has now been found that the specific molecular structure of the silane compound, for example the functional groups, significantly affect the hydrophobic and curing properties of the resultant coating composition. For example, those silanes having simpler structures and containing methyl groups tended to lead to coatings with the greatest hydrophobic properties but also cured rapidly, negatively affecting the ease of application. Silanes with more complex molecular structures and ethyl functional groups tended to result in products with slower rates of cure and reduced hydrophobic properties. Unexpectedly, particular mixtures of silane compounds of differing structures allowed formation of a coating composition with both a desirable slower rate of cure and desirable hydrophobic properties. Thus, various embodiments comprise a mixture of silane compounds.

Silanes on their own generally do not produce a coating with a significant amount of gloss or the slickness typically attributed to traditional protective coatings such as wax. This is the primary reason that available coating systems use an additional silicone based topcoat. To overcome this shortcoming in silane-based coatings, a siloxane component is included in the coating composition. Siloxanes provide gloss to the composition and are extremely hydrophobic. They also improve coating workability and impart self-leveling characteristics, which improves ease of application and further improves the curing properties of the coating.

According to various embodiments, siloxanes, which on their own do not produce a permanent coating and degrade over time, may be cross linked to alter the mechanical properties of siloxane. A silane in the coating composition may act as a cross-linker for siloxane and by choosing the appropriate silane cross-linker, it is possible to create a coating with high gloss and depth combined with incredible hardness, durability, and hydrophobicity. Therefore, coating compositions according to various embodiments also contain a siloxane with an appropriate silane cross-linker.

Dilute impurities (dopants) may drastically alter the properties of ceramic materials such as coatings. According to various embodiments, addition of titanium nanoparticles to the formula was found not only to improve coating flexibility without diminishing hardness, but also to improve dramatically the composition's hydrophobic properties. However, manufacturing with solid nanoparticles has the potential to create airborne particulates that would require further and specific engineering controls and personal protective equipment that would otherwise not necessarily be required for a liquid-based coatings manufacturing process, adding expense. Nanoparticles also must be adequately suspended to avoid product inconsistencies. To circumvent these issues, titanium diisopropoxide bis(acetylacetonate) is preferred as a dopant. It delivered the desired result in the formulations as well as avoiding unnecessary manufacturing difficulties for the coating.

The most highly preferred embodiment of the coating composition comprises or consists essentially of or consists of about 58% by weight trimethoxymethyl silane, about 20% by weight triethoxy(octyl)silane, about 20% by weight dimethylpolysiloxane, and about 2% by weight titanium diisopropoxide bis(acetylacetonate). In other embodiments, the trimethoxymethyl silane may be present at about 50% to about 65% by weight, the triethoxy(octyl)silane may be present at about 15% to about 25% by weight, the dimethylpolysiloxane may be present at about 18% to about 22% by weight, and the titanium diisopropoxide may be present at about 1.5% to about 4% by weight. See Table 1, below, for suitable ranges of components by weight. More preferred ranges include about 0.5% to about 8% titanium diisopropoxide bis(acetylacetonate), or about 1% to about 5% titanium diisopropoxide bis(acetylacetonate), or about 2% to about 4% titanium diisopropoxide bis(acetylacetonate); and about 5% to about 40% dimethylpolysiloxane, or about 10% to about 30% dimethylpolysiloxane, or about 15% to about 25% dimethylpolysiloxane; and about 1% to about 85% triethoxy(octyl)silane or about 5% to about 50% triethoxy(octyl)silane, or about 10% to about 30% triethoxy(octyl)silane; and about 10% to about 90% trimethoxymethylsilane, or about 25% to about 70% trimethoxymethylsilane, or about 45% to about 65% trimethoxymethylsilane. Various embodiments also include coating formulas that consist of or consist essentially of Titanium diisopropoxide bis(acetylacetonate), Dimethylpolysiloxane, Triethoxy(octyl)silane, and Trimethoxymethylsilane, containing the incidental solvents, contaminants and other materials/impurities in the commercially available chemical compounds, such as for example isopropanol.

TABLE 1
FORMULA COMPONENT RANGES.

| | Range, |
|---|---|
| Component | by weight |
| Titanium diisopropoxide bis(acetylacetonate), | 0.1% to 10% |
| 75% in isopropanol (Sigma Aldrich ™) | |
| Dimethylpolysiloxane (Dow Xiameter PM-200 | 1% to 50% |
| 1000 cSt | |
| Triethoxy(octyl)silane 97% purity (Sigma | 0% to 98.9% |
| Aldrich ™ deposition grade) | |
| Trimethoxymethylsilane 98% purity (Sigma | 0% to 98.9% |
| Aldrich ™ deposition grade) | |

Alternative components may be substituted for those listed above. Such alternatives include but are not limited to the following. Alternatives for trimethoxymethyl silane, triethoxy(octyl)silane, and dimethylpolysiloxane may be determined by one of skill in the art. An alternative for titanium diisopropoxide includes titanium nanoparticles.

The coating compositions may be produced by mixing the components together in a suitable container. In one embodiment, the components were added from highest weight percent to lowest weight percent and mixed with a 4 blade powered mechanical mixer until uniform at room temperature. The mixture may be stored in a sealed container. Each component is a liquid under ambient conditions. Except for dimethylpolysiloxane, all components are thin liquids with viscosity similar to or less than water. Dimethylpolysiloxane 1000 cSt is a viscous liquid. Upon blending, the final formulation's resulting mixture has a viscosity and consistency similar to water.

Preferably, the composition does not contain any appreciable further components or discernable other materials or impurities. For example, in certain embodiments, the coating composition preferably contains no dust or other particulates, no water, no nanoceramic particles, and no environmental contaminants, or the like. Some embodiments of the coating composition preferably do not contain any discernable or measurable additional components.

Coating compositions according to various embodiments may be applied to any substrate. Such suitable substrates include, but are not limited to, bare metal (for example, steel, iron, aluminum, copper, brass, bronze, and the like), treated metal, painted metal, fiberglass, gelcoat surfaces, powder coated surfaces, ceramics, composites, plastics (i.e., polycarbonate), glass, and the like. Preferred substrates include automobile painted surfaces, gel coated surfaces, boat hulls, aircraft, motorcycles, utility vehicles, personal watercraft, and the like.

The coating compositions according to various embodiments may be applied by any suitable method known in the art. For example, the product may be applied with a microfiber cloth or sponge, a brush, a sprayer, a microfiber applicator, and the like, or by dipping, pouring, or any other suitable method.

Once applied, the product is left to cure in a dry location for about 24 to about 72 hours at ambient conditions. Curing occurs through a mechanism of hydrolysis-condensation as a result of reaction with atmospheric humidity, causing silicon carbide and titanium silicon carbide to form on the treated surface. The structure and the surface energy of the coating create a super hydrophobic surface. The coating affects the chemical and electrochemical properties of the substrate as well as filling voids and imperfections, resulting in extremely low surface energy, low energy surfaces repel water and dirt.

Any article of manufacture that may benefit from antirust, antioxidation, lubricity, hydrophobicity, hardness, gloss, or having a reduced surface energy qualities is contemplated for use with the compositions according to various embodiments. Such articles of manufacture include but are not limited to: parts for automobile or other vehicle application (such as interior and exterior vehicle components), parts for marine application (such as antifouling coatings on internal surfaces of marine raw water cooling circuits, antifouling coatings for propellers, rudders, and other running gear, antifouling and protective coating for exterior and interior marine surfaces), parts for aircraft or aerospace application (such as anti-icing coatings for wings and propellers, thermal protective coatings for reciprocating engines and turbine parts), parts used in construction or manufacturing (such as heavy equipment buckets and other attachments, surfaces exposed to asphalt or concrete, foam insulation spraying equipment, masonry and concrete forms, shovels, spades, trowels, and the like), medical equipment (such as working surfaces, carts, autoclavable tools and instruments, and the like), fluid transfer pipes, and the like.

### Examples

The following examples are put forth to provide those of ordinary skill in the art with a complete disclosure and description of how to perform the methods, how to make, and how to use the compositions and compounds disclosed and claimed herein. Efforts have been made to ensure accuracy with respect to numbers (e.g., amounts, temperature, etc.), but some errors and deviations should be accounted for. The purpose of the following examples is not to limit the scope of the various embodiments, but merely to provide examples illustrating specific embodiments.

This disclosure is not limited to the particular processes, compositions, or methodologies described, as these may vary. The terminology used in the description is for the purpose of describing the particular versions or embodiments only and is not intended to limit the scope of the present disclosure which will be limited only by the appended claims. Although any methods and materials similar or equivalent to those described herein may be used in the practice or testing of various embodiments, the preferred methods, devices, and materials are described. All publications mentioned herein, are incorporated by reference in their entirety; nothing herein is to be construed as an admission that the disclosure is not entitled to antedate such disclosure by virtue of prior invention.

### Example 1A: Preparation of the Formulation

A formulation, according to one embodiment, was prepared as described in this example. The formulation was tested in the various other examples. The components specified in Table 2 were added from highest weight percent to lowest and mixed with a four-blade powered mechanical mixer until uniform. The mixture was stored in a sealed container. No pressure or temperature was applied. The formulation was mixed under ambient conditions. Each component was a liquid under ambient conditions. With the exception of dimethylpolysiloxane, all components are a thin liquid with viscosity similar to or less than that of water. Dimethylpolysiloxane 1000 cSt is a viscous liquid and upon blending the final formulation the resulting mixture had a viscosity and consistency similar to water. The components are listed as percent by weight of the total composition in Table 2, below.

TABLE 2
FORMULA COMPONENTS, PREFERRED EMBODIMENT.

| | Amount |
|---|---|
| Component | by weight |
| Titanium diisopropoxide bis(acetylacetonate), | 2.1% |
| 75% in isopropanol (Sigma Aldrich ™) | |
| Dimethylpolysiloxane (Dow Xiameter PM-200 | 20.6% |
| 1000 cSt | |
| Triethoxy(octyl)silane 97% purity (Sigma | 18.6% |
| Aldrich ™ deposition grade) | |
| Trimethoxymethylsilane 98% purity (Sigma | 58.7% |
| Aldrich ™ deposition grade) | |

### Example 1B: Preparation of Testing Coupons

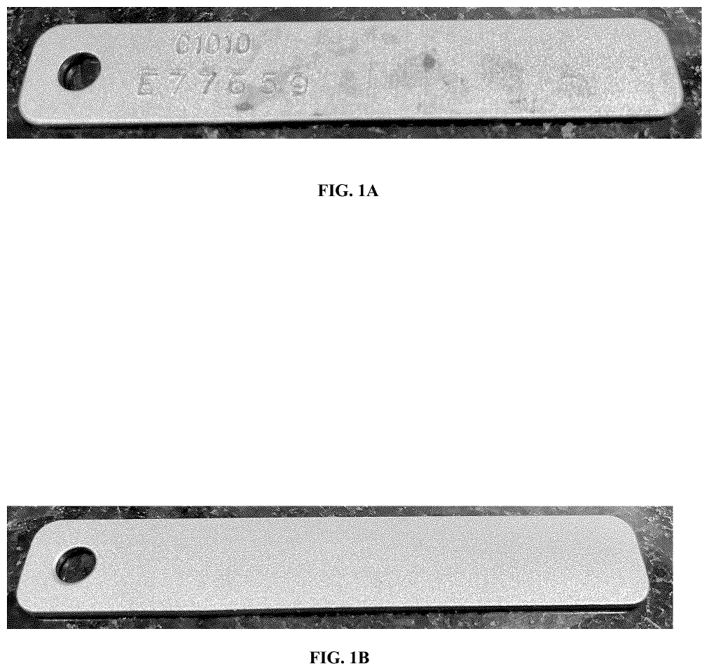

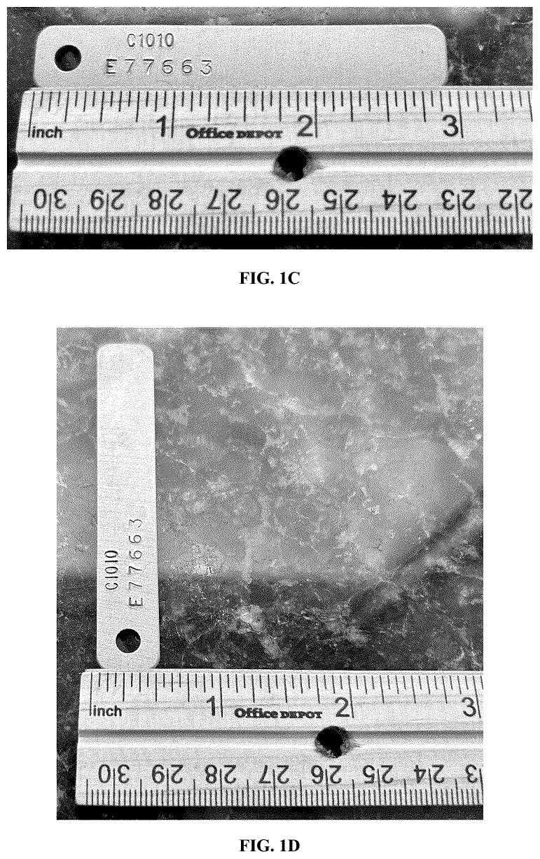

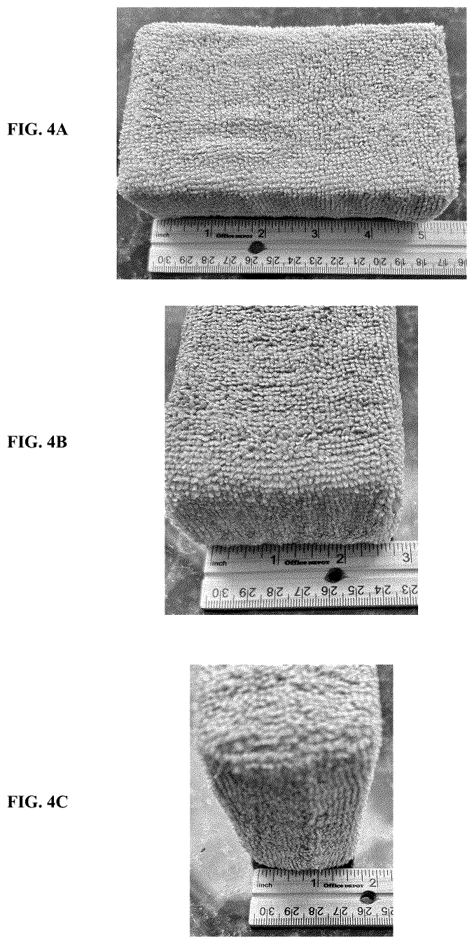

Coated coupons were prepared from standard lab coupons of C1010 Carbon Steel with a weight of 10.%59 grams. These coupons were used in the various examples. Each coupon had a flat, treatable surface measuring 3 inches by 0.5 inches, as shown in FIG. 1C and FIG. 1D. To coat each coupon, 0.0007 grams of the coating formulation of Example 1A was first applied to a microfiber applicator standard to the automotive detailing industry. A microfiber applicator is shown in FIGS. 4A, 4B, and 4C. The applicator has a length of about 5 inches, a width of about 2.75 inches, and a thickness of about 1.75 inches.

A coating was then applied to a coupon by wiping the substrate with the microfiber applicator that was wetted with the coating formulation of Example 1A. The coating, thus applied to the coupon was allowed to cure for 30 seconds and then wiped dry with a microfiber towel standard to the automotive detailing industry. The result was a coated coupon ready for use in the following examples.

### Example 2: Anti-Rust Testing

Carbon steel coupons prepared according to Example 1B as well as untreated carbon coupons were submerged in water briefly and hung to air dry at 74° F. for 24 hours. Twenty-four hours later, the untreated coupons and the untreated sides and edges of the treated coupons had developed surface rust but the treated faces of the coupons had not. FIG. 1A shows an example untreated metal coupon, showing multiple rust spots; FIG. 1B shows an example metal coupon treated with the formula according to Example 1 as described above, showing no rust.

### Example 3: Flame Resistance Testing

A commercially available two-sided microfiber cloth applicator sponge with a foam interior, as shown in FIGS. 4A. 4B, and 4C was treated with the coating formula of Example 1A by dripping several drops of the coating onto one side of the applicator and rubbing it back and forth across a painted metal surface. The applicator sponge was then allowed to cure for 3 days.

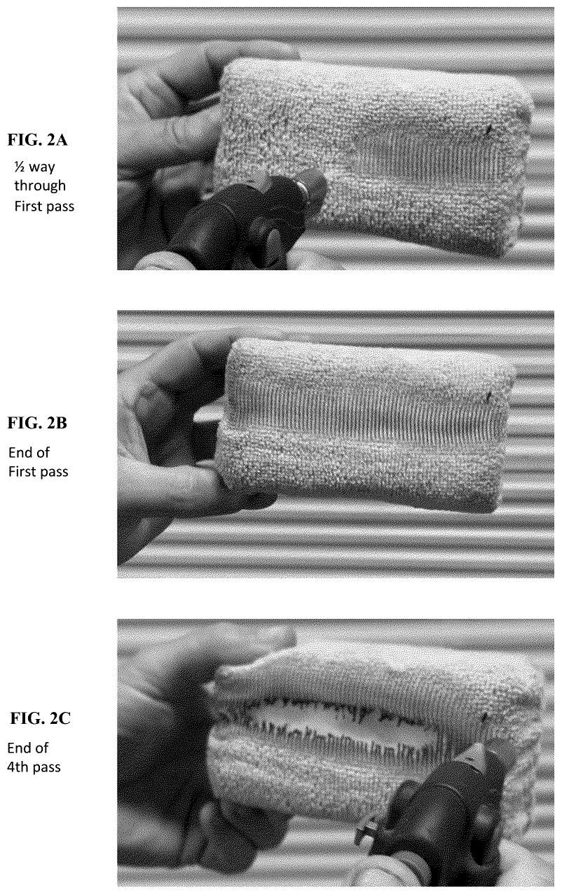

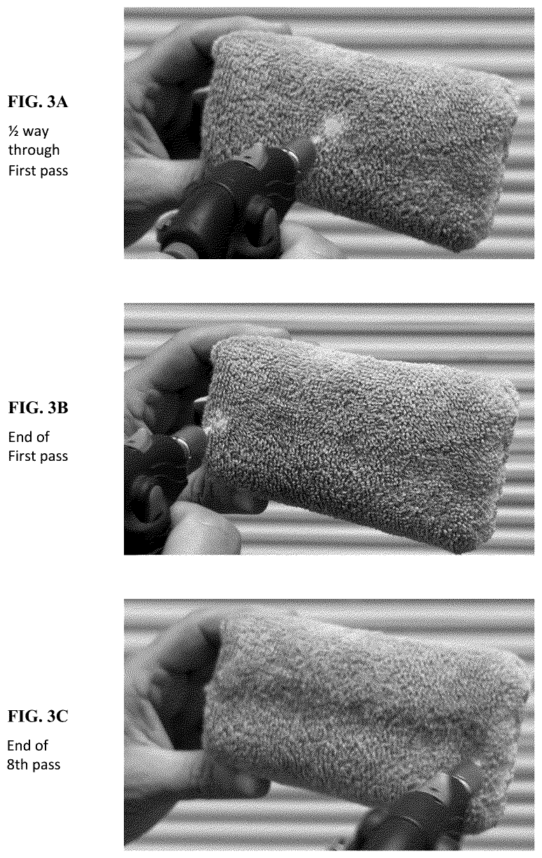

After curing for 3 days, the applicator sponge was subjected to passes with a butane torch over the surface of the untreated and the treated sides at a distance of about 2 inches and videotaped. See selected still frames from the video in FIGS. 2A, 2B, and 2C (untreated) and FIG. 3A. 3B, and 3C (treated).

FIG. 2A is first still frame image from a video demonstrating the consequences of exposing untreated cloth applicator sponge to a butane torch. The image in FIG. 2A was taken about halfway through a first pass with a butane torch from right to left across the untreated cloth applicator sponge at a distance of about 2 inches.

FIG. 2B is a second still frame image from a video demonstrating the consequences of exposing a first side of an untreated cloth applicator sponge to a butane torch. The second still frame image as shown in FIG. 2B was taken after the first full pass from right to left across the untreated cloth applicator sponge at a distance of about 2 inches.

FIG. 2C is an example according to various embodiments, illustrating a third still frame image from a video demonstrating the consequences of exposing a first side of an untreated cloth applicator sponge to a butane torch. The third still frame image as shown in FIG. 2C was taken after the four full passes across the untreated cloth applicator sponge at a distance of about 2 inches. Two of the four full passes were conducted from right to left and two were conducted from left to right.

FIG. 3A is a first still frame image from a video demonstrating the consequences of exposing a first side of a treated cloth applicator sponge, which has been in contact with a formulation according to Example 1, to a butane torch. The first still frame image as shown in FIG. 3A was taken about halfway through a first pass from right to left across the treated cloth applicator sponge at a distance of about 2 inches.

FIG. 3B is a second still frame image from the same video as for FIG. 3A. The second still frame image as shown in FIG. 3B was taken after the first full pass from right to left across the treated cloth applicator sponge at a distance of about 2 inches.

FIG. 3C is a third still frame image from the same video as for FIG. 3A. The third still frame image as shown in FIG. 3C was taken after the 8 full passes across the untreated cloth applicator sponge at a distance of about 2 inches. Four of the 8 full passes were conducted from right to left and four were conducted from left to right.

### Example 4: Durability Testing

Durability testing of the coating compositions were tested as follows. The superhydrophobic coating composition of Example 1A was applied to multiple automobiles, a boat hull, the exterior of an aircraft, and a personal watercraft by wiping with a microfiber sponge applicator. The surfaces were exposed to ambient atmospheric conditions for the time indicated in Tables 3 and 4. Results are indicated.

TABLE 3
DURABILITY TESTING I

| | | Time of | |
|---|---|---|---|
| | | Test | |
| Surface | Conditions of Test | (hours) | Result |
| Automobile | Ambient conditions, central Florida | 13,000 | ++++ |
| Boat Hull | Ambient marine conditions in south | 5000 | ++++ |
| | Florida on intercoastal waterway and | | |
| | Atlantic Ocean | | |
| Aircraft | Ambient conditions throughout | 6500 | ++++ |
| | continental United States, at altitude | | |
| | and in hangar in central Florida | | |
| Watercraft | Ambient conditions, south Florida | 6000 | ++++ |
| Automobile | Ambient conditions, central Florida | 7000 | ++++ |
| Automobile | Ambient conditions, central Florida | 9000 | ++++ |

++++ indicates no discernable wear or degradation.

TABLE 4
DURABILITY TESTING II, TEST PANELS.

| | | Time of | |
|---|---|---|---|
| | | Test | |
| Surface | Conditions of Test | (hours) | Result |
| Automobile | Ambient conditions, central Florida | 5000 | ++++ |
| fender | | | |
| Stainless steel | Ambient conditions, central Florida | 4000 | ++++ |
| panel | | | |

++++ indicates no discernable wear or degradation.

The coating composition according to Example 1A has undergone a combined 30,000+ hours of real-world durability testing, having been applied to numerous vehicles, boats, watercraft, and aircraft, as well as additional test panels. The longest single test has been ongoing for over 13,000 hours exposed to the elements with no maintenance or reapplication. There have so far been no coating failures nor has any noticeable degradation in coating performance occurred over the time of the testing.

### Example 5: Bare Metal Durability Testing

Additional testing was performed on C1010 carbon steel coupons prepared according to show application and cure of the superhydrophobic coating composition of Example 1A on a bare, untreated metal surface and to determine whether the coating offers protection as observed on painted surfaces as shown above. The metal coupons were cleaned by scouring the surface with a green SCOTCH BRITE™ abrasive pad and then placing them in an ultrasonic cleaner for 3 minutes. Upon removal from the ultrasonic cleaner, the coupons were rinsed and then cleaned with USP grade isopropyl alcohol and a CHEMWIPE™ was used to remove any organic material from the surface. Once allowed to dry, the coupons were coated as described in Example 1B using a microfiber applicator but were allowed to cure at room temperature for 72 hours. Coated and uncoated carbon steel coupons were dipped in water and subjected to room temperature at 80% relative humidity for 24 hours. These tests have shown that the untreated coupons as well as the untreated sides and edges of the treated coupons had developed surface rust, but the treated faces of the coupons had not. The coating is, therefore, able to protect bare steel from surface rust and corrosion by rendering the exposed surface hydrophobic.

### Example 6: Hardness Testing

Coating hardness was tested according to ASTM D3363-20 “Standard Test Method for Film Hardness by Pencil Test.” A test panel of automotive grade steel as finished in a high quality automotive grade paint by a professional according to industry standard methods and procedures. After the paint was properly cured, the superhydrophobic coating composition of Example 1A was applied using a microfiber applicator as described in Example 1B, but was allowed to cure for 72 hours under ambient conditions.

A GOLDENWALL™ brand mechanical pencil holder weighing 500 grams which holds the lead at a 45-degree angle to the surface was used. The pencils used were MITSUBISHI UNI™ brand hardness testing pencils conforming to ASTM D3363 standards. They were prepared in accordance with ASTM D3363-20. The Lot numbers for the pencils are as follows:
Mitsubishi Uni 9H—Lot #18LC282
Mitsubishi Uni 7H—Lot #191C250
Mitsubishi Uni 4H—Lot #19CC259
Mitsubishi Uni 2H—Lot #19HC255

The testing was performed in accordance with ASTM D3363-20 “Standard Test Method for Film Hardness by Pencil Test.” Testing was conducted in a climate controlled laboratory at 74° F. and 50% humidity. The test was repeated 3 times for each pencil hardness starting from 9H and working down. The pencil holder was loaded with each pencil and pushed across the surface approximately ¼ of an inch. Prior to each repeated test, the pencil was prepared again to the standard by sanding the end to achieve a uniform 90-degree surface.

The results of the test indicate the coated substrate/coupon achieved a 9H gouge hardness and a scratch hardness of 7H. The untreated substrate/coupon achieved a gouge hardness of 4H.

Precise scratch hardness of the untreated painted surface was not determined. The softest available pencil available for the test was a 2H which still visibly scratched the untreated substrate.

The improvement in hardness was significant. Most impressive was the scratch hardness of the ceramic coated substrate which was several units of hardness greater than the gouge hardness of the untreated substrate. Without wishing to be bound by theory, it is believed that part of what created such an impressive result is the slickness of the surface when treated with the coating. The untreated surface has considerable drag when compared to the treated surface that can be easily felt when passing a hand lightly over both surfaces. This reduction in drag is not characteristic of most commercially available ceramic coatings. Most coatings do not impart a slickness or gloss and require a secondary step to enhance gloss and impart slickness to the surface.

### Example 7: Preliminary Hydrophobicity Testing

Plain (bare) 1010 carbon steel coupons were coated as described in Example 1B with the superhydrophobic coating composition of Example 1A containing varying amounts of titanium diisopropoxide bis(acetylacetonate) ranging from 0%-5% by weight in half percent intervals and allowed to cure. Water droplets were then placed on the surface of the coupons using a pipette. The droplet contact angle was observed both visually and under magnification with a microscope. The results of these tests showed that addition of titanium diisopropoxide bis(acetylacetonate) to the coating formulation positively affected hydrophobic properties and resulted in greater droplet contact angle. Above 3% by weight, the improvement in droplet contact angle began to taper off.

### Example 8: Treatment of a Painted Car Hood

The formula of Example 1A was applied to a car hood as follows. The hood received industry standard paint correction and was cleaned with isopropyl alcohol after paint correction was completed and prior to coating application. The coating was applied to the car hood using a microfiber sponge applicator of the type previously described. Several drops of the coating liquid were put on the applicator, and it was applied to the hood in a back and forth motion and allowed to flash for approximately 60 seconds. It was then buffed smooth to remove excess material and level the coating using a clean, dry microfiber cloth. The coating was allowed to fully cure for 72 hours prior to being tested.

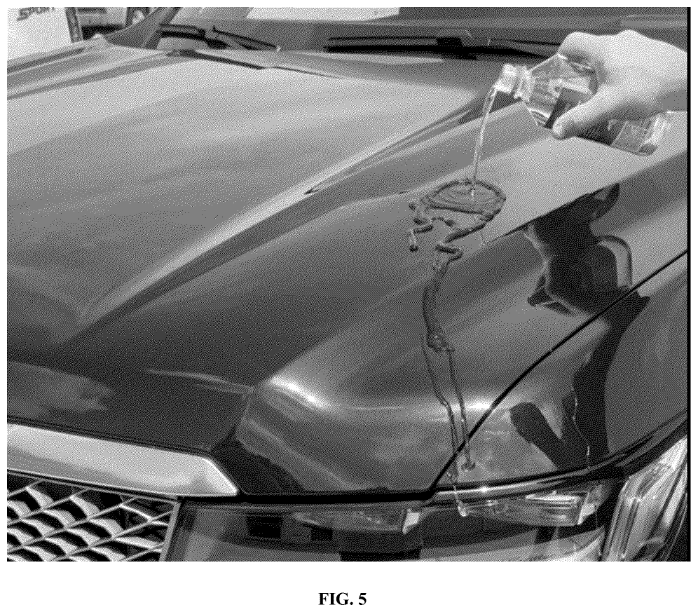

The car hood was tested by pouring water over the treated car hood. The surface remained dry and the water ran off the surface completely as shown in FIG. 5.

### Example 9: Contact Angle Testing

A purpose of the test was to determine the contact angles with de-ionized water of the coating of Example 1A as applied to substrate samples. The specimens that underwent testing and analysis reported here were a ceramic coating on three substrate samples prepared according to Example 1B. The samples will be referred to as Sample 1, Sample 2, and Sample 3.

The analytical instrument used for contact angle measurement of the specimens is the Contact Angle Meter model DM-701, made by Kyowa Interface Science Co., Ltd. (Tokyo. Japan), which is a fully automatic contact angle measurement instrument.

To determine the contact angles of the coating on the three substrate specimens, 10 droplets of de-ionized water were deposited on each sample surface. All liquid drops were 2 μL in volume. All samples were tested as received. Table 5 summarizes the testing conditions and parameters used in the contact angle tests.

TABLE 5
CONTACT ANGLE TESTING CONDITIONS
AND PARAMETERS

| | |
|---|---|
| Testing Liquid | De-ionized water |
| Solid Specimen | coating on 3 substrate specimens |
| Test Instrument | DM-701 Contact Angle Meter |
| Dispenser | 22-gauge stainless steel coated needle |
| Drop Size | 2 μL |
| Environment | 72° F., 50% RH |

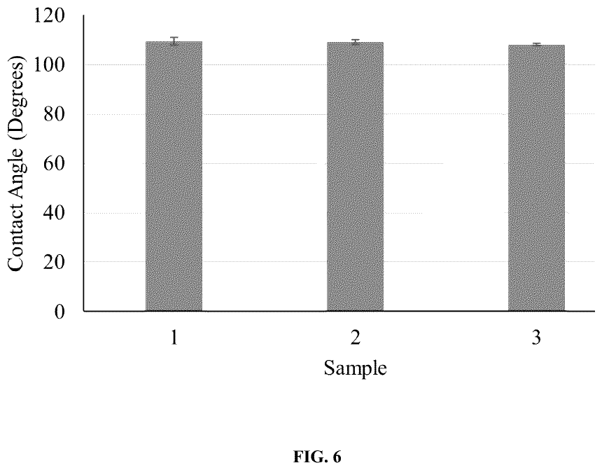

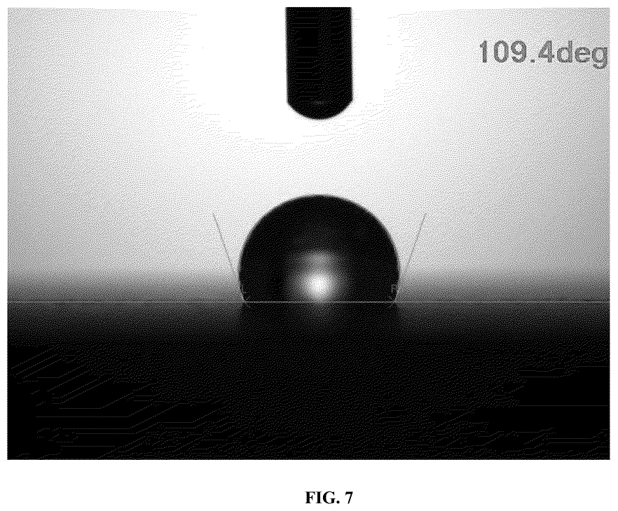

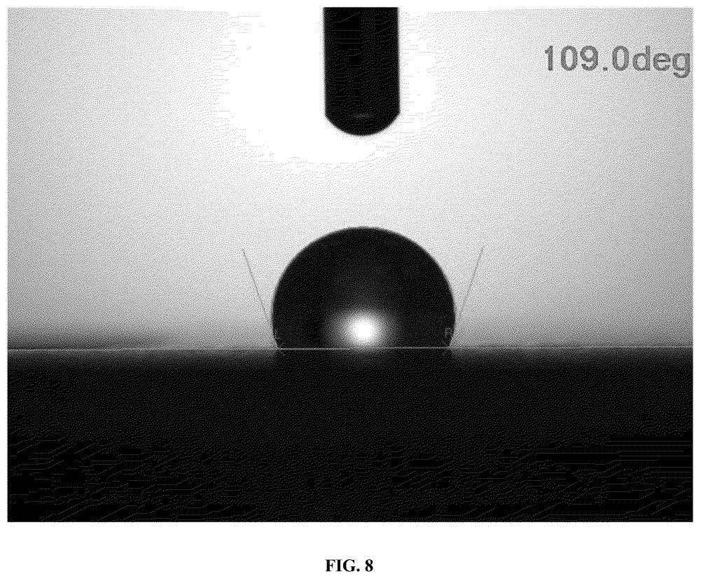

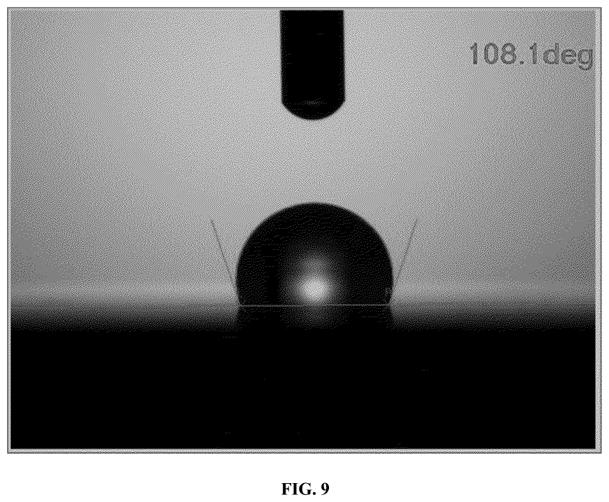

Table 6 presents the contact angle measurement results for each specimen as well as the average contact angle of all specimens and the standard deviation. FIG. 6 presents a plot of the average contact angle measurements for each specimen. FIGS. 7, 8, and 9 are typical images used for contact angle analysis of each sample.

TABLE 6
CONTACT ANGLE RESULTS FOR ALL SPECIMENS

| | Sample 1 | Sample 2 | Sample 3 |
|---|---|---|---|
| Test | (Degrees) | (Degrees) | (Degrees |
| 1 | 108.2 | 109.0 | 108.5 |
| 2 | 108.1 | 108.6 | 108.4 |
| 3 | 106.5 | 108.3 | 107.2 |
| 4 | 108.3 | 109.8 | 108.5 |
| 5 | 110.3 | 110.0 | 107.9 |
| 6 | 110.2 | 106.9 | 108.6 |
| 7 | 112.0 | 108.4 | 108.2 |
| 8 | 110.7 | 110.1 | 107.2 |
| 9 | 109.0 | 109.1 | 107.6 |
| 10 | 109.4 | 109.3 | 108.1 |
| Average | 109.3 | 109.0 | 108.0 |
| S.D. | 1.6 | 1.0 | 0.5 |

### Further Definitions and Cross-References

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A superhydrophobic coating composition comprising:
(a) about 0% to about 98.9% by weight trimethyoxymethylsilane, 98% pure;
(b) about 0% to about 98.9% by weight triethoxy(octyl)silane, 97% pure;
(c) about 1% to about 50% by weight dimethylpolysiloxane; and
(d) about 0.1% to about 10% by weight titanium diisopropoxide bis(acetylacetonate) 75% in isopropanol.

2. The superhydrophobic coating composition of claim 1, comprising:
(a) about 10% to about 90% by weight trimethyoxymethylsilane, 98% pure;
(b) about 1% to about 85% by weight triethoxy(octyl)silane, 97% pure;
(c) about 5% to about 40% by weight dimethylpolysiloxane; and
(d) about 0.5% to about 8% by weight titanium diisopropoxide bis(acetylacetonate) 75% in isopropanol.

3. The superhydrophobic coating composition of claim 1, comprising:
(a) about 25% to about 70% by weight trimethyoxymethylsilane, 98% pure;
(b) about 5% to about 50% by weight triethoxy(octyl)silane, 97% pure;
(c) about 10% to about 30% by weight dimethylpolysiloxane; and
(d) about 1% to about 5% by weight titanium diisopropoxide bis(acetylacetonate) 75% in isopropanol.

4. The superhydrophobic coating composition of claim 1, comprising:
(a) about 45% to about 65% by weight trimethyoxymethylsilane, 98% pure;
(b) about 10% to about 30% by weight triethoxy(octyl)silane, 97% pure;
(c) about 15% to about 25% by weight dimethylpolysiloxane; and
(d) about 2% to about 4% by weight titanium diisopropoxide bis(acetylacetonate) 75% in isopropanol.

5. The superhydrophobic coating composition of claim 1, comprising:
(a) about 58.7% by weight trimethyoxymethylsilane, 98% pure;
(b) about 18.6% by weight triethoxy(octyl)silane, 97% pure;
(c) about 20.6% by weight dimethylpolysiloxane; and
(d) about 2.1% by weight titanium diisopropoxide bis(acetylacetonate) 75% in isopropanol.

6. An article of manufacture coated with the superhydrophobic coating composition of claim 1.

7. An article of manufacture coated with the superhydrophobic coating composition of claim 5.
